(19) United States
(12) Patent Application Publication
(10) Pub. No.: US 2024/0176134 A1
(43) Pub. Date: May 30, 2024

(54) METHOD AND DEVICE FOR DETERMINING TARGET PARAMETERS OF POLARIZER, POLARIZER AND DEBUGGING SYSTEM

(71) Applicants: QINGDAO HAIRIGAO TECHNOLOGY CO., LTD., Qingdao (CN); HAIER SMART HOME CO.,LTD, Qingdao (CN)

(72) Inventors: Jianhui HUANG, Qingdao (CN); Tai WANG, Qingdao (CN)

(73) Assignees: QINGDAO HAIRIGAO TECHNOLOGY CO., LTD., Qingdao (CN); HAIER SMART HOME CO.,LTD, Qingdao (CN)

(21) Appl. No.: 17/791,874

(22) PCT Filed: Dec. 15, 2021
(86) PCT No.: PCT/CN2021/138381

§ 371 Date: Jul. 8, 2022

(30) Foreign Application Priority Data
Mar. 4, 2021 (CN) 202110239931.7

(51) Int. Cl. G02B 27/00; G01M 11/02; G02B 5/30

(52) U.S. Cl. CPC G02B 27/0012; G01M 11/02; G02B 5/30

(57) ABSTRACT

The present application relates to the field of intelligent home appliance technologies, and discloses a method for determining target parameters of a polarizer, including: obtaining light parameters of a display lamp which will use a polarizer and a target visual effect; and simulating a light effect of the polarizer by a debugging system and determining the target parameters of the polarizer by adjusting the light effect, such that a superposition visual effect of the polarizer under the target parameters and the display lamp is matched with the target visual effect. In the present application, the target parameters of the polarizer can be accurately determined by the debugging system, thus facilitating manufacture of the polarizer meeting visual requirements, avoiding repeated debugging and manufacturing operations, and saving time and cost.

### CROSS-REFERENCE TO RELATED APPLICATIONS

The present application is the National Stage of International Application No. PCT/CN2021/138381, filed on Dec. 15, 2021, which is based on and claims a priority of the Chinese Patent Application No. 202110239931.7 filed on Mar. 4, 2021, the disclosure of which is incorporated in its entirety as reference herein.

### TECHNICAL FIELD

The present application relates to the field of intelligent home appliance technologies, and in particular, to a method and a device for determining target parameters of a polarizer, a polarizer and a debugging system.

### BACKGROUND

Currently, color films/cover plates are used on display lamps of more and more electrical products, and after utilization of the color film/cover plate, light of the display lamp is transmitted through the color film/cover plate and subjected to color deviation due to an influence of surrounding materials of a light source, such that a displayed optical effect does not meet requirements of an industrial designer. In order to make the display effect of the light meet the industrial design requirements, a color of the light of the display lamp is usually adjusted, or different polarizers are replaced many times for debugging.

During implementation of embodiments of the present disclosure, a related art is found to at least have the following problem: when a polarizer is manufactured, an engineer is required to repeatedly print the polarizer on a polarizer printer to debug parameters depending on personal experience, thereby wasting time and materials.

### SUMMARY

In order to provide a basic understanding of some aspects of the disclosed embodiments, a brief summary is given below. This summary is not intended to be an extensive review, nor to identify key/critical elements or to delineate the scope of protection of these embodiments, but rather serves as a prelude to the detailed description that follows.

Embodiments of the present disclosure provide a method and a device for determining target parameters of a polarizer, a polarizer and a debugging system, so as to solve a technical problem that a polarizer is required to be printed repeatedly to debug parameters, thus wasting time and materials.

In some embodiments, the method includes: obtaining light parameters of a display lamp which will use a polarizer and a target visual effect; and simulating a light effect of the polarizer by a debugging system and determining the target parameters of the polarizer by adjusting the light effect, such that a superposition visual effect of the polarizer under the target parameters and the display lamp is matched with the target visual effect.

In some embodiments, the polarizer is manufactured according to target parameters after the target parameters are determined according to the foregoing embodiment.

In some embodiments, the device includes: an acquiring unit configured to obtain light parameters of a display lamp which will use a polarizer and a target visual effect; and a determining unit configured to simulate a light effect of the polarizer by a debugging system and determine the target parameters of the polarizer by adjusting the light effect, such that a superposition visual effect of the polarizer under the target parameters and the display lamp is matched with the target visual effect.

In some embodiments, the debugging system includes: a simulating device configured to simulate a light effect of a polarizer; and an adjusting device configured to obtain light parameters of a display lamp which will use a polarizer and a target visual effect, and determine target parameters of the polarizer by adjusting the light effect, such that a superposition visual effect of the polarizer under the target parameters and the display lamp is matched with the target visual effect.

The method for determining target parameters of a polarizer and the polarizer according to the embodiments of the present disclosure may have the following technical effects: The light effect of the polarizer is simulated by the debugging system, and the target parameters of the polarizer are determined by adjusting the light effect, such that the superposition visual effect of the polarizer under the target parameters and the display lamp is matched with the target visual effect, thereby accurately manufacturing the polarizer meeting visual requirements, avoiding repeated printing and debugging operations, and saving time and cost. For different light effects of the display lamp, parameters of the polarizer are adjusted to achieve a personalized display effect and improve adaptability between parameters of the display lamp and the polarizer, thus more accurately determining the target parameters of the polarizer.

The above general description and the following description are merely exemplary and explanatory and are not intended to limit the present application.

### BRIEF DESCRIPTION OF THE DRAWINGS

One or more embodiments are exemplified by corresponding drawings. These exemplified descriptions and the drawings do not constitute a limitation on the embodiments. Elements with the same reference numerals in the drawings are denoted as similar elements. The accompanying drawings do not constitute a scale limitation, and in the drawings:

FIG. 1 is a schematic diagram of a method for determining target parameters of a polarizer according to an embodiment of the present disclosure;

FIG. 2 is a schematic diagram of another method for determining target parameters of a polarizer according to an embodiment of the present disclosure;

FIG. 3 is a schematic diagram of another method for determining target parameters of a polarizer according to an embodiment of the present disclosure;

FIG. 4 is a schematic diagram of a device for determining target parameters of a polarizer according to an embodiment of the present disclosure;

FIG. 5 is a schematic diagram of a debugging system according to an embodiment of the present disclosure; and

FIG. 6 is a schematic diagram of another debugging system according to an embodiment of the present disclosure.

### DETAILED DESCRIPTION OF THE EMBODIMENTS

In order to understand features and technical contents of the embodiments of the present disclosure in more details, implementations of the embodiments of the present disclosure will be described in detailed hereunder in combination with the accompanying drawings. The accompanying drawings are only for reference and illustration, but not intended to limit the embodiments of the present disclosure. In the following technical description, for the convenience of explanation, a thorough understanding of the disclosed embodiments is provided through multiple details. However, without these details, one or more embodiments can still be implemented. In other cases, for simplification of the accompanying drawings, well-known structures and devices may be demonstrated in a simplified way.

The terminologies “first”, “second”, etc. in the specification, claims and aforesaid drawings of the embodiments of the present disclosure are used for distinguishing similar objects, but not necessarily for describing the specific order or sequence. It should be understood that the data so used may be interchanged as appropriate for the embodiments of the present disclosure described herein. Furthermore, the terms “including” and “having” and any variations thereof are intended to cover non-exclusive inclusion.

The term “a plurality of” means two or more unless otherwise stated.

In the embodiments of the present disclosure, the character “/” indicates an “or” relationship between associated objects. For example, A/B represents A or B.

The term “and/or” is an association relationship for describing objects and represents that three relationships may exist. For example, A and/or B represents the following three relationships: A, or B, or A and B.

A polarizer is also called a polarizing plate and usually attached to a surface of a liquid crystal display. A surface of the polarizer is frosted, which may dissipate surface reflection and scatter light to increase a viewing angle of the liquid crystal display. Light of a display lamp may be subjected to color deviation after passing through the polarizer.

With reference to FIG. 1, an embodiment of the present disclosure provides a method for determining target parameters of a polarizer, including:
S11: obtaining light parameters of a display lamp which will use a polarizer and a target visual effect; and
S21: simulating a light effect of the polarizer by a debugging system and determining the target parameters of the polarizer by adjusting the light effect, such that a superposition visual effect of the polarizer under the target parameters and the display lamp is matched with the target visual effect.

In the embodiment of the present disclosure, the polarizer may be determined by the debugging system, such that the superposition visual effect of the polarizer under the target parameters and the display lamp is matched with the target visual effect. Specifically, the light parameters of a display lamp which will use a polarizer and the target visual effect may be obtained, the light effect of the polarizer is simulated by the debugging system, the light effect is adjusted, and the target parameters of the polarizer are determined according to the above-mentioned parameters.

In the embodiment of the present disclosure, the light effect of the polarizer is simulated by the debugging system, and the target parameters of the polarizer are determined by adjusting the light effect, such that the superposition visual effect of the polarizer under the target parameters and the display lamp is matched with the target visual effect, thereby accurately manufacturing the polarizer meeting visual requirements, avoiding repeated printing and debugging operations, and saving time and cost. For different light effects of the display lamp, parameters of the polarizer are adjusted to achieve a personalized display effect and improve adaptability between parameters of the display lamp and the polarizer, thus more accurately determining the target parameters of the polarizer. After the target parameters of the polarizer are determined using the method according to the embodiment of the present disclosure, the polarizers may be conveniently manufactured in batches subsequently, thus improving a manufacturing efficiency.

The light parameters of the display lamp, the target visual effect and the target parameters of the polarizer are correlated, and the target parameters of the polarizer may be precisely determined based on the obtained light parameters and target visual effect, such that the visual effect of the display lamp with the superposed polarizer meets industrial design requirements.

The target visual effect is an effect expected to be presented by the display lamp with the polarizer, i.e., an expected visual effect of superposition of the display lamp and the polarizer. The target visual effect may be preset in the debugging system in a parameter form, so as to compare the visual effect of superposition with the target visual effect.

After the polarizer is manufactured using the target parameters, the visual effect of superposed light formed after superposition of the polarizer and light of the display lamp may reach the target visual effect, and the target parameters are light parameters required for manufacturing the polarizer. The target parameters are, for example, RGB values and/or HSL values. RGB refers to colors of a red channel, a green channel and a blue channel, and HSL includes hue, saturation and lightness. The superposed light refers to light formed after the light of the display lamp passes through the polarizer.

As an example, the light parameters of the display lamp may be detected by providing a color sensor on a light path of the display lamp. As an example, the light parameters of the display lamp may be detected by a PR930 optical test apparatus.

As an example, the superposition visual effect of the polarizer and the display lamp may be detected by providing a color sensor. As an example, the superposition visual effect of the polarizer and the display lamp may be detected by a PR930 optical test apparatus.

As an example, a polarizer manufacturing apparatus is controlled to manufacture the polarizer according to the target parameters of the polarizer, such that the superposition visual effect of the polarizer and the display lamp is matched with the target visual effect. The polarizer manufacturing apparatus manufactures the polarizer according to the target parameters, such that the polarizer meeting the visual requirements may be manufactured accurately, and repeated debugging and manufacturing operations are avoided, thus saving the time and cost.

As an example, the polarizer manufacturing apparatus may print the polarizer according to the target parameters. The polarizer is printed based on the target parameters, which is accurate and fast.

As an example, the debugging system controls the polarizer manufacturing apparatus to manufacture the polarizer according to the target parameters of the polarizer, such that the superposition visual effect of the polarizer and the display lamp is matched with the target visual effect. The polarizer manufacturing apparatus may be controlled to manufacture the polarizer by the debugging system.

As an example, a control module controls the polarizer manufacturing apparatus to manufacture the polarizer according to the target parameters of the polarizer, such that the superposition visual effect of the polarizer and the display lamp is matched with the target visual effect. A control module may be provided to control the polarizer manufacturing apparatus to manufacture the polarizer.

As an example, the debugging system obtains the light parameters of a display lamp which will use a polarizer and the target visual effect. The light parameters of a display lamp which will use a polarizer and the target visual effect may be acquired by the debugging system.

As an example, an acquiring module obtains the light parameters of a display lamp which will use a polarizer and the target visual effect, and sends signals of the light parameters of a display lamp which will use a polarizer and the target visual effect to the debugging system. An acquiring module may be provided to obtain the above-mentioned parameters and send the parameters to the debugging system.

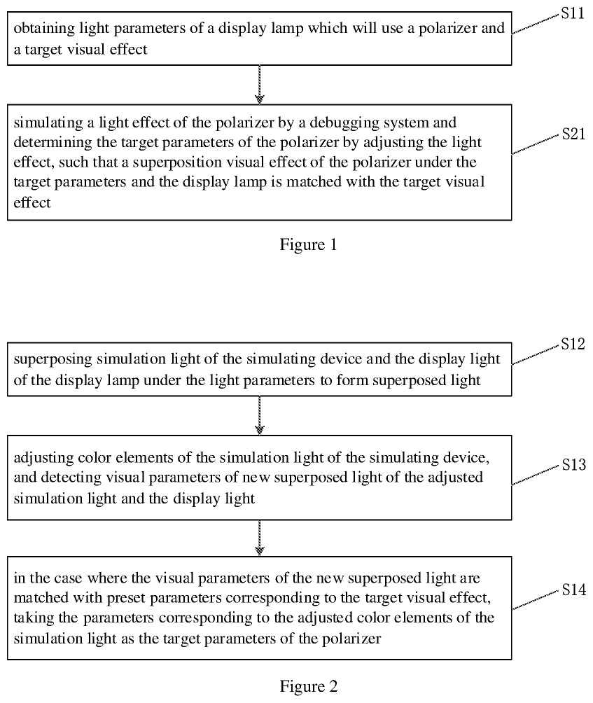

With reference to FIG. 2, in some embodiments, the debugging system includes a simulating device for simulating the light effect of the polarizer, and the simulating a light effect of the polarizer by a debugging system and determining the target parameters of the polarizer by adjusting the light effect includes:
S12: superposing simulation light of the simulating device and the display light of the display lamp under the light parameters to form superposed light;
S13: adjusting color elements of the simulation light of the simulating device, and detecting visual parameters of new superposed light of the adjusted simulation light and the display light; and
S14: in the case where the visual parameters of the new superposed light are matched with preset parameters corresponding to the target visual effect, taking the parameters corresponding to the adjusted color elements of the simulation light as the target parameters of the polarizer.

In the embodiment of the present disclosure, the light effect of the polarizer is simulated by the simulating device, the simulation light of the simulating device and the light of the display lamp are superposed to form the superposed light, and at this point, if the color elements of the simulation light of the simulating device are adjusted, the visual effect of the superposed light also changes. The visual parameters of the new superposed light of the adjusted simulation light and the display light are detected, and if the parameters are matched with the preset parameters corresponding to the target visual effect, the visual effect of the superposed light reaches the target visual effect. At this point, the parameters corresponding to the adjusted color elements of the simulation light are used as the target parameters of the polarizer, the polarizer is manufactured, and when the polarizer is superposed on the display lamp, a same effect as that of the simulating device may be generated, such that the superposed light achieves the target visual effect.

With the present embodiment, for the display lamps with different visual effects, parameters of the polarizers may be adjusted, such that the superposed light achieves the personalized display effect, and the adaptability between the parameters of the display lamp and the polarizer is improved, thus more accurately manufacturing the polarizer.

In the embodiment of the present disclosure, the polarizer is simulated by the simulating device to transfer adjustment of the parameters of the polarizer to adjustment of the parameters of the simulating device, such that the parameters of the polarizer may be conveniently adjusted and accurately determined by the debugging system, which is more accurate and efficient and saves the cost compared with a traditional method of printing the polarizer many times for adjustment.

In the embodiment of the present disclosure, the light effect of the adjusted superposed light is detected, and the adjusted superposed light may be considered to meet the design requirements in the case where the visual parameters of the new superposed light are matched with the preset parameters corresponding to the target visual effect. As an example, the superposition visual effect of the polarizer and the display lamp may be detected by a PR930 optical test apparatus.

In an actual processing process, the preset parameters may be specific values; for example, the preset parameters include RGB values which are 23, 25, and 43 respectively, or parameter intervals, such as a preset RGB parameter interval and/or an HSL parameter interval. If the RGB values belong to the RGB parameter interval, the adjusted superposed light achieves the target visual effect. If HSL values belong to the HSL interval, the adjusted superposed light achieves the target visual effect.

The color elements include RGB and/or HSL. The light of the simulating device may present different visual effects by adjusting the color elements of the light of the simulating device. RGB represents colors of a red channel, a green channel and a blue channel. Each of an R value, a G value, and a B value for RGB has 256 levels of lightness represented numerically as 0 to 255. A total of about 16,780,000 colors may be combined by the 256 levels of RGB colors. As an example, the adjustment of the color elements of the light of the simulating device may be adjustment of the RGB. For example, the simulating device is adjusted to have an R value of 29, a G value of 44, and a B value of 29.

HSL includes hue, saturation, and lightness. Each of an H value, an S value, and an L value for HSL ranges from 0 to 240. As an example, the adjustment of the color elements of the light of the simulating device may be adjustment of HSL. For example, the simulating device is adjusted to have an H value of 80, an L value of 47, and an S value of 35.

The RGB values and the HSL values may be converted into one another; for example, the detected RGB values may be converted into the HSL values, and vice versa. As an example, the RGB values are converted to the HSL values by correction normalization. The human eye may more directly perceive hue, saturation and lightness of light, such that the conversion of the RGB values into the HSL values may improve light adjustment precision.

As an example, the simulating device may be an RGB light bar. The adoption of the RGB light bar facilitates the adjustment of the color elements thereof. Optionally, the RGB light bar includes a plurality of LED lamps. The LED lamp occupies a small space, is easy to amount and dismount, and may be conveniently provided on the display lamp for light superposition. As an example, the LED lamp receives the RGB values and displays corresponding light. As an example, the LED lamp receives the HSL values and displays corresponding light.

Optionally, the simulating device is provided above the display lamp, and a color film/cover plate is provided above the simulating device, such that the superposed light is superposition of the light of the display lamp, the light of the simulating device, and light of the color film/cover plate. Thus, the polarizer manufactured according to the determined target parameters can achieve the target visual effect after the light is transmitted through the polarizer and the color film/cover plate, thus meeting the industrial design requirements.

As an example, the visual parameters of the new superposed light of the adjusted simulation light and the display light may be detected by providing a light detection device outside the color film/cover plate. Optionally, the light detection device is a PR930 optical test apparatus or a color sensor.

In some embodiments, the visual parameters of the new superposed light include: RGB values and/or HSL values. The RGB values or the HSL values may reflect the visual effect of the light in a parameter form, and whether the new superposed light achieves the target visual effect may be judged by detecting the above-mentioned parameters and judging whether the parameters are matched with the preset parameters.

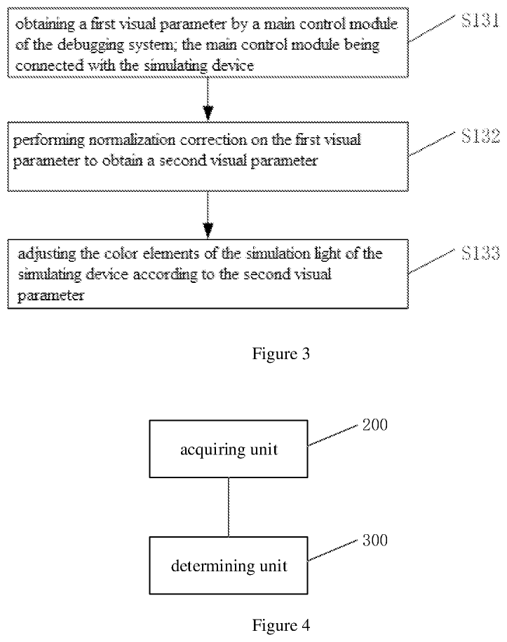

With reference to FIG. 3, in some embodiments, the adjusting color elements of the simulation light of the simulating device includes:
S131: obtaining a first visual parameter by a main control module of the debugging system; the main control module being connected with the simulating device;
S132: performing normalization correction on the first visual parameter to obtain a second visual parameter; and
S133: adjusting the color elements of the simulation light of the simulating device according to the second visual parameter.

In the embodiment of the present disclosure, the first visual parameter is subjected to the normalization correction to obtain the second visual parameter, and then, the color elements of the simulating device are adjusted according to the second visual parameter. If the simulating device is directly adjusted using the first visual parameter obtained by the main control module, a deviation exists between the visual effect generated by the simulating device and a visual effect actually corresponding to the first visual parameter, and after the first visual parameter is corrected, the simulating device is adjusted according to the corrected second visual parameter, thus eliminating the deviation and realizing the more accurate color adjustment of the simulating device. The first visual parameter is corrected to obtain the second visual parameter, the color elements of the simulating device are adjusted using the second visual parameter, and when the superposed light achieves the target visual effect, the target parameters of the polarizer can be determined more accurately, thereby more accurately manufacturing the polarizer.

The main control module may acquire the first visual parameter, correct the first visual parameter to obtain the second visual parameter, and adjust the color elements of the simulating device according to the second visual parameter.

As an example, the first visual parameter is the RGB and the second visual parameter is the HSL. The human eye may intuitively sense the HSL(hue, saturation, lightness), and when the RGB values are converted into the HSL values, the HSL values are then sent to a display module, and a user may precisely debug the color elements of the simulating device.

In some embodiments, the obtaining a first visual parameter by a main control module of the debugging system includes:
obtaining, by the debugging system, the first visual parameter input by the user through the display module; and
sending, by the display module, the first visual parameter to the main control module.

In the embodiment of the present disclosure, the debugging system obtains the first visual parameter input by the user through the display module, and the first visual parameter is sent to the main control module, such that the main control module may perform subsequent adjustment.

The display module may display the visual parameters for convenient viewing. As an example, the display module is a display module of a terminal apparatus. The terminal apparatus may be, for example, a mobile apparatus, a computer, a vehicle-mounted apparatus built in a floating vehicle, or the like, or any combination thereof. In some embodiments, the mobile apparatus may include, for example, a mobile phone, a smart home apparatus, a wearable apparatus, a smart mobile apparatus, a virtual reality apparatus, or the like, or any combination thereof. As another example, a tester may input the visual parameters by the display module.

Optionally, the display module is a TFT module. A thin film transistor (TFT) is a thin film field effect transistor which belongs to a kind of active matrix liquid crystal display. The visual parameters may be input and output by the TFT module. Optionally, serial port communication is adopted between the TFT module and the main control module.

In some embodiments, the display lamp is a home appliance display lamp. In the embodiment of the present disclosure, the light parameters of a display lamp which will use a polarizer and the target visual effect are obtained, and the target parameters of the polarizer are determined by the debugging system according to the above parameters, thereby manufacturing the polarizer suitable for being applied to the home appliance display lamp. The polarizer manufactured using the method enables the light of the home appliance display lamp to achieve the target visual effect after transmitted through the polarizer, thus meeting the industrial design requirements.

In some embodiments, the target parameters include the RGB values and/or the HSL values. The RGB values and/or the HSL values of the simulating device may reflect the visual effect thereof, and after the RGB values and/or the HSL values of the simulating device are used as the target parameters of the polarizer, the polarizer manufactured based on the target parameters may also generate the light effect of the simulating device. When the polarizer is applied to the display lamp, the superposed light may achieve the target visual effect.

An embodiment of the present disclosure further provides a polarizer, which is manufactured according to target parameters after the target parameters are determined using the method according to any one of the foregoing embodiments. With the polarizer manufactured using the method according to any one of the foregoing embodiments, the superposition visual effect after the light of the display lamp is transmitted through the polarizer may be matched with the target visual effect, thus meeting industrial design requirements.

With reference to FIG. 4, an embodiment of the present disclosure further provides a device for determining target parameters of a polarizer, including:
an acquiring unit 200 configured to obtain light parameters of a display lamp which will use a polarizer and a target visual effect; and
a determining unit 300 configured to simulate a light effect of the polarizer by the debugging system and determine the target parameters of the polarizer by adjusting the light effect, such that a superposition visual effect of the polarizer under the target parameters and the display lamp is matched with the target visual effect.

In the device according to the embodiment of the present disclosure, the light parameters of a display lamp which will use a polarizer and a target visual effect may be obtained by the acquiring unit 200, and the target parameters of the polarizer may be accurately determined by the determining unit 300, such that the superposition visual effect of the polarizer and the display lamp is matched with the target visual effect, thus meeting industrial design requirements, avoiding repeated debugging and manufacturing operations, and saving time and cost. With the device, the polarizers may be conveniently manufactured in batches subsequently, thus improving a manufacturing efficiency.

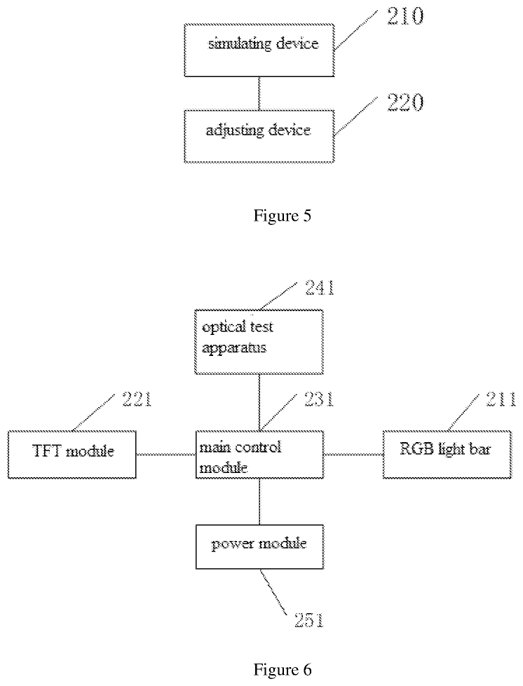

With reference to FIG. 5, an embodiment of the present disclosure further provides a debugging system, including:
a simulating device 210 configured to simulate a light effect of a polarizer; and
an adjusting device 220 configured to obtain light parameters of a display lamp which will use a polarizer and a target visual effect, and determine target parameters of the polarizer by adjusting the light effect, such that a superposition visual effect of the polarizer under the target parameters and the display lamp is matched with the target visual effect.

In the debugging system according to the embodiment of the present disclosure, the light effect of the polarizer is simulated by the simulating device 210, and the target parameters of the polarizer are determined by the adjusting device 220, such that the polarizer may be accurately manufactured, and the superposition visual effect of the polarizer and the display lamp may reach the target visual effect, thus meeting industrial design requirements. With the debugging system, for different light effects of the display lamp, parameters of the polarizer are adjusted to achieve a personalized display effect and improve adaptability between parameters of the display lamp and the polarizer, thus more accurately manufacturing the polarizer.

In some embodiments, the adjusting device includes a processor and a detector, wherein the processor is configured to superpose simulation light of the simulating device and display light of the display lamp under the light parameters to form superposed light, adjust color elements of the simulation light of the simulating device, and in the case where visual parameters of new superposed light are matched with preset parameters corresponding to the target visual effect, take parameters corresponding to the adjusted color elements of the simulation light as the target parameters of the polarizer; and the detector is configured to detect the visual parameters of the new superposed light of the adjusted simulation light and the display light.

In the embodiment of the present disclosure, the adjustment of the light and the determination of the target parameters of the polarizer are realized by the mutual cooperation of the processor and the detector.

With reference to FIG. 6, the debugging system exemplarily includes:
an RGB light bar 211 configured to simulate the light effect of the polarizer;
a TFT module 221 configured to acquire a first visual parameter and send the first visual parameter to a main control module;

the main control module 231 configured to acquire the first visual parameter sent by a TFT, correct the first visual parameter to obtain a second visual parameter, adjust the RGB light bar based on the second visual parameter, and take visual parameters of the RGB light bar as the target parameters of the polarizer in the case where the adjusted visual parameters of the superposed light belong to preset parameter intervals;
an optical test apparatus 241 configured to detect the visual parameters of the new superposed light of the adjusted simulation light of the simulating device and the display light of the display lamp; and
a power module 251 configured to supply power to the main control module.

With the debugging system, the color elements of the RGB light bar may be adjusted, such that the superposition visual effect of the simulation light of the RGB light bar and the display light of the display lamp may reach the target visual effect, and the visual parameters corresponding to the RGB light bar are used as the target parameters of the polarizer.

The technical solutions of the embodiments of the present disclosure may be implemented in the form of a software product. The computer software product is stored in a storage medium and includes one or more instructions for instructing a computer apparatus (which may be a personal computer, a server, or a network apparatus, or the like) to execute all or a part of steps of the method according to the embodiment of the present disclosure. The aforementioned storage medium may be a non-transitory storage medium, including: any medium that can store program codes, such as a USB flash disk, a removable hard disk, a read-only memory (ROM), a random access memory (RAM), a magnetic disk, or an optical disk, or may be a transient storage medium.

The above description and the drawings sufficiently illustrate the embodiments of the present disclosure to enable those skilled in the art to practice them. Other embodiments may incorporate structural, logical, electrical, process, and other changes. The embodiments merely typify possible variations. Unless expressly required, individual components and functions are optional and the order of operations may vary. Portions and features of some embodiments may be included in or substituted for those of other embodiments. Moreover, the terms used in this application are used to describe the embodiments only and not to limit the claims. As used in the descriptions of the embodiments and the claims, the singular forms “a”, “an” and “the” are intended to include the plural forms as well, unless the context clearly indicates otherwise. Similarly, the term “and/or” as used in this application represents containing any and all possible combinations of one or more associated listed items. In addition, the term “comprise” and its variants “comprises” and/or “comprising”, etc., when used in this application, specify the presence of stated features, integers, steps, operations, elements, and/or assemblies, but do not preclude the presence or addition of one or more other features, integers, steps, operations, elements, assemblies, and/or groups thereof. With no more restrictions, elements defined by sentence “include one . . . ” do not exclude other same elements in the process, method, or apparatus including said elements. Herein, every embodiment may illustrate in emphasis what is different from the other embodiments. The same or similar parts in the embodiments may be references to each other. If methods, products, etc. according to the embodiments correspond to the method sections according to the embodiments, reference may be made to the descriptions of the method sections for relevant parts.

Those skilled in the art may be aware that, in combination with the examples described in the embodiments disclosed in this specification, units and algorithm steps can be implemented by electronic hardware, or a combination of computer software and electronic hardware. Whether the functions are executed by hardware or software may depend on particular applications and design constraint conditions of the technical solutions. Those skilled in the art may use different methods to implement the described functions for each particular application, but it should not be considered that the implementation goes beyond the scope of the embodiments of the present disclosure. It may be clearly understood by those skilled in the art that, for the purpose of convenient and brief description, for a detailed working process of the foregoing system, device, and unit, reference may be made to a corresponding process in the method embodiments, and details are not described herein again.

In the embodiments disclosed herein, the disclosed methods and products (including, but not limited to, devices, apparatuses, or the like) may be implemented in other manners. For example, the described device embodiment is merely exemplary. For example, the unit division may be merely logical function division and may be other division in actual implementation. For example, multiple units or assemblies may be combined or integrated into another system, or some features may be ignored or not performed. In addition, the displayed or discussed mutual couplings or direct couplings or communication connections may be implemented through some interfaces. The indirect couplings or communication connections between the devices or units may be implemented in electronic, mechanical, or other forms. The units described as separate parts may or may not be physically separate, and parts displayed as units may or may not be physical units, may be located in one position, or may be distributed on a plurality of network units. A part or all of the units may be selected according to an actual need to achieve the embodiments. In addition, functional units in the embodiments of the present disclosure may be integrated into one processing unit, or each of the units may exist alone physically, or two or more units are integrated into one unit.

The flowcharts and block diagrams in the drawings illustrate the architecture, functionality, and operation of possible implementations of systems, methods and computer program products according to the embodiments of the present disclosure. In this regard, each block in the flowchart or block diagrams may represent a module, program segment, or portion of code, which includes one or more executable instructions for implementing the specified logical function(s). In some alternative implementations, the functions noted in the block may occur out of the order noted in the figures. For example, two successive blocks may, in fact, be executed substantially concurrently, or the blocks may sometimes be executed in the reverse order, depending upon the functionality involved. In the descriptions corresponding to the flowcharts and block diagrams in the drawings, operations or steps corresponding to different blocks may also occur out of the order disclosed in the description, and sometimes, there is no specific order between different operations or steps. For example, two successive operations or steps may, in fact, be executed substantially concurrently, or the operations or steps may sometimes be executed in the reverse order, depending upon the functionality involved. Each block of the block diagrams and/or flowcharts, and combinations of blocks in the block diagrams and/or flowcharts, can be implemented by special purpose hardware-based systems that perform the specified functions or acts, or combinations of special purpose hardware and computer instructions.

1. A method for determining target parameters of a polarizer, comprising:
obtaining light parameters of a display lamp which will use a polarizer and a target visual effect; and
simulating a light effect of the polarizer by a debugging system and determining the target parameters of the polarizer by adjusting the light effect, such that a superposition visual effect of the polarizer under the target parameters and the display lamp is matched with the target visual effect.

2. The method according to claim 1, wherein the debugging system comprises a simulating device for simulating the light effect of the polarizer, and the simulating a light effect of the polarizer by a debugging system and determining the target parameters of the polarizer by adjusting the light effect comprises:
superposing simulation light of the simulating device and display light of the display lamp under the light parameters to form superposed light;
adjusting color elements of the simulation light of the simulating device, and detecting visual parameters of new superposed light of the adjusted simulation light and the display light; and
in the case where the visual parameters of the new superposed light are matched with preset parameters corresponding to the target visual effect, taking parameters corresponding to the adjusted color elements of the simulation light as the target parameters of the polarizer.

3. The method according to claim 2, wherein the adjusting color elements of the simulation light of the simulating device comprises:
obtaining a first visual parameter by a main control module of the debugging system; the main control module being connected with the simulating device;
performing normalization correction on the first visual parameter to obtain a second visual parameter; and
adjusting the color elements of the simulation light of the simulating device according to the second visual parameter.

4. The method according to claim 3, wherein the obtaining a first visual parameter by a main control module of the debugging system comprises:
obtaining, by the debugging system, the first visual parameter input by a user through a display module; and
sending, by the display module, the first visual parameter to the main control module.

5. The method according to claim 1, wherein the target parameters comprise RGB values and/or HSL values.

6. The method according to claim 1, wherein the display lamp is a home appliance display lamp.

7. A polarizer manufactured according to target parameters after the target parameters are determined using a method for determining target parameters of a polarizer;
wherein the method for determining target parameters of a polarizer comprises:
obtaining light parameters of a display lamp which will use a polarizer and a target visual effect; and
simulating a light effect of the polarizer by a debugging system and determining the target parameters of the polarizer by adjusting the light effect, such that a superposition visual effect of the polarizer under the target parameters and the display lamp is matched with the target visual effect.

8. A device for determining target parameters of a polarizer, comprising:
an acquiring unit configured to obtain light parameters of a display lamp which will use a polarizer and a target visual effect; and
a determining unit configured to simulate a light effect of the polarizer by a debugging system and determine the target parameters of the polarizer by adjusting the light effect, such that a superposition visual effect of the polarizer under the target parameters and the display lamp is matched with the target visual effect.

9. A debugging system, comprising:
a simulating device configured to simulate a light effect of a polarizer; and
an adjusting device configured to obtain light parameters of a display lamp which will use a polarizer and a target visual effect, and determine target parameters of the polarizer by adjusting the light effect, such that a superposition visual effect of the polarizer under the target parameters and the display lamp is matched with the target visual effect.

10. The debugging system according to claim 9, wherein the adjusting device comprises:
a processor configured to superpose simulation light of the simulating device and display light of the display lamp under the light parameters to form superposed light, adjust color elements of the simulation light of the simulating device, and in the case where visual parameters of new superposed light are matched with preset parameters corresponding to the target visual effect, take parameters corresponding to the adjusted color elements of the simulation light as the target parameters of the polarizer; and
a detector configured to detect the visual parameters of the new superposed light of the adjusted simulation light and the display light.

11. The method according to claim 2, wherein the target parameters comprise RGB values and/or HSL values.

12. The method according to claim 3, wherein the target parameters comprise RGB values and/or HSL values.

13. The method according to claim 4, wherein the target parameters comprise RGB values and/or HSL values.

14. The method according to claim 2, wherein the display lamp is a home appliance display lamp.

15. The method according to claim 3, wherein the display lamp is a home appliance display lamp.

16. The method according to claim 4, wherein the display lamp is a home appliance display lamp.

17. The polarizer according to claim 7, wherein the debugging system comprises a simulating device for simulating the light effect of the polarizer, and the simulating a light effect of the polarizer by a debugging system and determining the target parameters of the polarizer by adjusting the light effect comprises:
superposing simulation light of the simulating device and display light of the display lamp under the light parameters to form superposed light;
adjusting color elements of the simulation light of the simulating device, and detecting visual parameters of new superposed light of the adjusted simulation light and the display light; and
in the case where the visual parameters of the new superposed light are matched with preset parameters corresponding to the target visual effect, taking parameters corresponding to the adjusted color elements of the simulation light as the target parameters of the polarizer.

18. The polarizer according to claim 17, wherein the adjusting color elements of the simulation light of the simulating device comprises:
obtaining a first visual parameter by a main control module of the debugging system; the main control module being connected with the simulating device;
performing normalization correction on the first visual parameter to obtain a second visual parameter; and
adjusting the color elements of the simulation light of the simulating device according to the second visual parameter.

19. The polarizer according to claim 18, wherein the obtaining a first visual parameter by a main control module of the debugging system comprises:
obtaining, by the debugging system, the first visual parameter input by a user through a display module; and
sending, by the display module, the first visual parameter to the main control module.

20. The polarizer according to claim 7, wherein the target parameters comprise RGB values and/or HSL values.
